(19) United States
(12) Patent Application Publication
(10) Pub. No.: US 2017/0013809 A1
(43) Pub. Date: Jan. 19, 2017

(54) A RELEASABLY SUBMERSIBLE FLOAT ASSEMBLY AND ITS USE IN AQUACULTURE

(71) Applicant: The Cawthron Institute Trust Board, Nelson (NZ)

(72) Inventor: Kevin HEASMAN, Nelson (NZ)

(73) Assignee: The Cawthron Institute Trust Board, Nelson (NZ)

(21) Appl. No.: 15/114,361

(22) PCT Filed: Jan. 27, 2014
(86) PCT No.: PCT/NZ2014/000008

§ 371 Date: Jul. 26, 2016

(30) Foreign Application Priority Data
Jan. 25, 2013 (NZ) 606310

(51) Int. Cl. A01K 61/00

(52) U.S. Cl. CPC A01K 61/007; A01K 61/002

(57) ABSTRACT

A relesably submersible float assembly comprising a float body and a retainer is disclosed. In one application the assembly is for use in conjunction with a mooring line to releasably submerse support lines for growing ropes used in aquaculture.

### FIELD OF INVENTION

The invention relates to a releasably submersible float assembly and its use in aquaculture, in particular the marine aquaculture of the bivalve mollusc Perna canaliculus.

### BACKGROUND ART

Mussels may be grown on rafts, stakes (the bouchot system used in France), longlines and suspended socks (mesh tubes) or laid directly onto the seabed (Bardack et al (1972), Koringa (1976), Lutz (1974, 1979 and 1980), Hulburt and Hulburt (1980)). Off-bottom culture systems using suspension techniques have become more common than on-bottom culture systems because they are widely adaptable. Harvested or reared spat are transferred to a substrate such as a growing rope. In raft culture systems, spat are attached to ropes suspended from the raft. In longline culture systems, spat are attached to ropes suspended from floats on the water surface or weighted below the surface (Creswell and McNevin (2008)).

The bivalve mollusc Perna canaliculus (Green lipped mussel) is an important aquaculture species in New Zealand with production valued in excess of NZ$250 million per annum. A longline culture system used for the marine aquaculture of P. canaliculus in the Marlborough Sounds of New Zealand is the “double backbone” configuration. The system consists of a series of large plastic surface buoys or floats attached between a pair of support lines tethered at each end to concrete anchor blocks or steel anchors screwed in to the seabed. The growing ropes are suspended in the water column from this “double backbone”. The buoyancy of the surface buoys or floats is sufficient to support the weight of the ropes and growing mussels. Surface buoys or floats may be added to the “double backbone” as required.

Culture systems that are located on the surface of the water are exposed to wave action. Marine aquaculture of P. canaliculus is typically undertaken in sheltered embayments, within 200 m of the low-water mark, and in water between 10 and 30 m deep (Lloyd (2003)). Submerging the culture system reduces exposure to wave action and potentially extends the marine area over which marine aquaculture can be undertaken.

For raft culture systems, submersible self-supporting frames have been developed (Quinta Cortinas et al (2005)). In these submersible raft culture systems the growing ropes are hung from the arms of the self-supporting frame. The structure moves vertically under the effect of tide or the weight of the growing mussels. The structure is guided by means of surface floats with a guide tube comprising slide stop elements between which the structure can move. Alternative configurations for submersible self-supporting frames have more recently been proposed (Diaz Arbonez (2010)).

In longline culture systems, submersible configurations have also been proposed (Cortinas et al (2004)). In these submersible longline culture systems a line of cables bearing the growing ropes and cylindrical buoys to maintain the line horizontal is suspended from end floats. The line is raised or submerged by filling or emptying the end floats using water by way of ballast. Tension in the line is maintained by submerged tension buoys connected to the end floats by tension cables and pulleys fixed to dead-weights provided at either end of the line.

The submersible culture systems employ mechanical parts that require regular maintenance and servicing to ensure reliable operation, particularly in a marine environment. It is an object of the present invention to provide a submersible culture system that substantially avoids this limitation of known systems. It is an object of the present invention to provide a float assembly for use in the submersible culture system. These objects are to be read disjunctively with the object at least to provide a useful choice.

### STATEMENT OF INVENTION

In a first aspect the invention provides a releasably submersible float assembly for use with a mooring line comprising:
a float body having a conduit through which the mooring line may pass; and
a retainer that releasably engages with the mooring line to maintain the float body at a desired depth.

Preferably, the releasable engagement of the retainer with the mooring line is actuated by the float body abutting the retainer.

The float body is of a mean density less than the medium in which the assembly is to be immersed. Typically the medium is estuarine, lake, river or marine water. The float body may most advantageously be used in marine water.

In a first alternative the retainer is not tethered to the float body and is of a mean density less than the medium in which the assembly is immersed. The buoyancy of the retainer facilitates its recovery if it is inadvertently separated from the float body when the releasably submersible float assembly is in use.

In a second alternative the retainer is tethered to the float body and is of a mean density greater than the medium in which the assembly is immersed. The lack of buoyancy of the retainer facilitates cooperative engagement with the float body when the releasably submersible float assembly is in use.

In a third alternative the retainer is slidably held within a sleeve fixed to the float body coaxial with the conduit through which the mooring line may pass.

The largest radially measured dimension of the retainer when engaged with the mooring line is greater than the smallest radially measured dimension of the conduit through which the mooring line passes. Therefore, when the retainer is engaged with the mooring line the float body cannot rise above the location of the retainer and is maintained at the desired depth.

Preferably, the conduit through which the mooring line passes is through the body of the float body. More preferably, the upper open mouth of the conduit through which the mooring line passes is dimensioned to receive the retainer. Most preferably, the upper open mouth of the conduit through which the mooring line passes is dimensioned to receive the retainer and participate in cooperative engagement with the mooring line.

Preferably, at least a portion of the outer surface of the body of the retainer has a tapered profile. More preferably, the retainer is a split collar with at least a portion of the outer surface of the body of the retainer having a tapered profile. Most preferably, the retainer is a split collar with at least a portion of the outer surface of the body of the retainer having a tapered profile complementary to the profile of the inner surface of the upper open mouth of the conduit through which the mooring line passes.

Preferably, the float body is provided with at least one or more means for retaining support lines. More preferably, the float body is provided with at least one or more means for releasably retaining support lines.

The means for retaining support lines may take the form of eye rings through which the support lines may pass in a direction substantially at right angles to the direction of the mooring line or additional conduits through the body of the float body through which the support lines may pass in a direction substantially at right angles to the direction of the mooring line.

In a particularly preferred embodiment of the first aspect the invention provides a releasably submersible float assembly for use with a mooring line and two support lines comprising:
an arcuate flattened elongate float body with integral rigidity providing spars projecting radially from around a centrally located conduit through which the mooring line may pass and at least one means for releasably retaining one of the two support lines located at or proximal to each end of the float body; and
a retainer slidably held within a sleeve attached to the upper surface of the float body coaxial with the conduit.

Preferably, the at least one means for releasably retaining one of the two support lines is a pair of means for releasably retaining one of the two support lines.

In a second aspect the invention provides a submersible culture system comprising at least one support line retained at a desired depth by a plurality of float assemblies where each of the float assemblies is releasably engaged with a mooring line.

Preferably, the float assemblies are the releasably submersible float assemblies of the first aspect of the invention.

In a third aspect the invention provides a method of culturing bivalve mollusc in submerged culture comprising the use of the submersible culture system of the first aspect of the invention.

In a fourth aspect the invention provides an arcuate flattened elongate float body with integral rigidity providing spars projecting radially from around a centrally located conduit through which a mooring line may pass and at least one means for releasably retaining a support line located at or proximal to each end of the float body.

Preferably, the at least one means for releasably retaining one of the two support lines is a pair of means for releasably retaining one of the two support lines.

In the description and claims of this specification the following acronyms, terms and phrases have the meaning provided: “comprising” means “including”, “containing” or “characterized by” and does not exclude any additional element, ingredient or step; “conduit” means a circular or tubular void through which a line may pass; “consisting of” means excluding any element, ingredient or step not specified except for impurities and other incidentals; “cooperative engagement” means engagement by two or more components acting in concert; “desired depth” means a predetermined depth below the surface; “engaging” means coming or fitting together and holding in place without relative movement of the holding and held parts; “flattened” means the dimensions length and width are each multiples of the dimension thickness; “mean density” means the weight of an object divided by the volume of the object typically expressed in units of grams per millilitre (g/mL); “mooring line” means a line anchored below the surface and rising through the water column; “radially measured” means a measurement made perpendicular to the longitudinal axis of a line; “retaining” means holding in place while allowing some relative movement of the holding and held parts; “support line” means a line from which growing ropes may be hung.

The terms “first”, “second”, “third”, etc. used with reference to elements, features or integers of the subject matter defined in the Statement of Invention and Claims, or when used with reference to alternative embodiments of the invention are not intended to imply an order of preference. Where values are expressed to one or more decimal places standard rounding applies. For example, 1.7 encompasses the range 1.650 recurring to 7.499 recurring.

The invention will now be described with reference to embodiments or examples and the figures of the accompanying drawings pages.

### BRIEF DESCRIPTION OF DRAWINGS

FIG. 1. Side views of an embodiment of the releasably submersible float assembly. The illustrations show a mooring line (4) passing through both a float body (2) and a retainer (3). Receiving of the retainer (3) by the upper open mouth of the conduit passing through the float body (2) (as indicated by the arrows in FIG. 1A) promotes cooperative engagement of the float body (2) and the retainer (3) with the mooring line (4) (as indicated by the arrows in FIG. 1B).

FIG. 2. Perspective views of embodiments of the releasably submersible float assembly. The perspective views show a conduit passing through the body of the float body (2) with a bell-shaped upper open mouth. The shape of the upper open mouth facilitates cooperative engagement of the retainer (3) with the mooring line (4). In this alternative, the retainer is provided with a releasing handle (13) to facilitate disengagement. In the embodiment illustrated in FIG. 2A the float body is provided with eye rings (9, 10). In the embodiment illustrated in FIG. 2B the float body is provided with two additional conduits. The support lines (5) pass through the eye rings (9, 10) or the additional conduits in a direction substantially at right angles to the direction of the mooring line (4).

FIG. 3. Plan views of embodiments of the releasably submersible float assembly illustrated in FIGS. 1 and 2. The plan views show alternative versions of the retainer (3); a tapered, split collar (FIG. 3A) and a pair of complementary tapered wedges (FIG. 3B). In either version, the retainer (3) is provided with a releasing handle (13) to facilitate disengagement.

FIG. 4. Plan views of the particularly preferred embodiment of the releasably submersible float assembly (1) showing the upper (FIG. 4A) and lower (FIG. 4B) surfaces of the substantially flat elongate float body (2) with integral rigidity providing spars (18) projecting radially from around the centrally located conduit through which the mooring line is passing (support lines not shown).

FIG. 5. Perspective views of the particularly preferred embodiment of the releasably submersible float assembly (1) engaged with a mooring line (4) showing the upper (FIG. 5A) and lower (FIG. 5B) surfaces of the substantially flat elongate float body (2) with integral rigidity providing spars (18) projecting radially from around the centrally located conduit through which the mooring line (4) is passing (support lines not shown).

FIG. 6. Side view of the particularly preferred embodiment of the releasably submersible float assembly (1) and a mooring line (4) (support lines not shown).

FIG. 7. Cross-sectional view through sections A-A and C-C, respectively, of the particularly preferred embodiment of the releasably submersible float assembly (1) before (A) and after (B) cooperative engagement of the float body (2) and the retainer (3) with a mooring line (4) (support lines not shown).

FIG. 8. An underwater side view of a longline culture system employing the “double backbone” configuration and incorporating five of the particularly preferred embodiment of the releasably submersible float assembly.

### DETAILED DESCRIPTION

The invention resides at least in part in a releasably, submersible float assembly (1). The assembly provides many of the advantages provided by the releasably submersible floats described in the publications of Fiotakis (1991) and Oettinger (2002). The assembly (1) comprises a float body (2) and a retainer (3). The retainer (3) may be tethered to the float body (2) so that the two components of the assembly (1) are not inadvertently separated during use. The float body (2) is adapted for use in conjunction with a mooring line (4). Typically, a mooring line will be anchored to the estuary, lake, river or sea bed and be attached to a float at the surface. The float body (2) may be further adapted for use with one or more support lines (5). The retainer (3) is also adapted for use in conjunction with the mooring line (4). The retainer (3) functions to engage with the mooring line (4) either in isolation or in cooperation with the float body (2), most advantageously in cooperation with the the float body (2) (“cooperative engagement”). The retainer (3) serves to prevent the float body (2) rising to the surface of the medium in which it is immersed.

The float body (2) is necessarily of a mean density less than that of the medium in which it is to be immersed so that it is buoyant. The float body (2) is typically hollow and fabricated from a rigid material, e.g. blown plastic, although solid floats made from buoyant material such as wood may also be used. When used in conjunction with support floats (15), it is not necessary for the float body (2) to be of a mean density significantly less than that of the medium in which it is immersed. The difference in densities need merely be sufficient to ensure the float body (2) has a degree of buoyancy and is urged towards the surface when immersed in the medium. The medium will be estuarine, lake, river or marine water. A mean density of less than 1 g/mL will typically be all that is required. However, where the retainer (3) functions to engage with the mooring line (4) in cooperation with the float body (2), and the float assembly (1) is used in isolation, e.g. to support monitoring or scientific instruments below the surface, a float body (2) with a mean density significantly less than 1 g/mL or a large volume will be required to provide sufficient buoyancy.

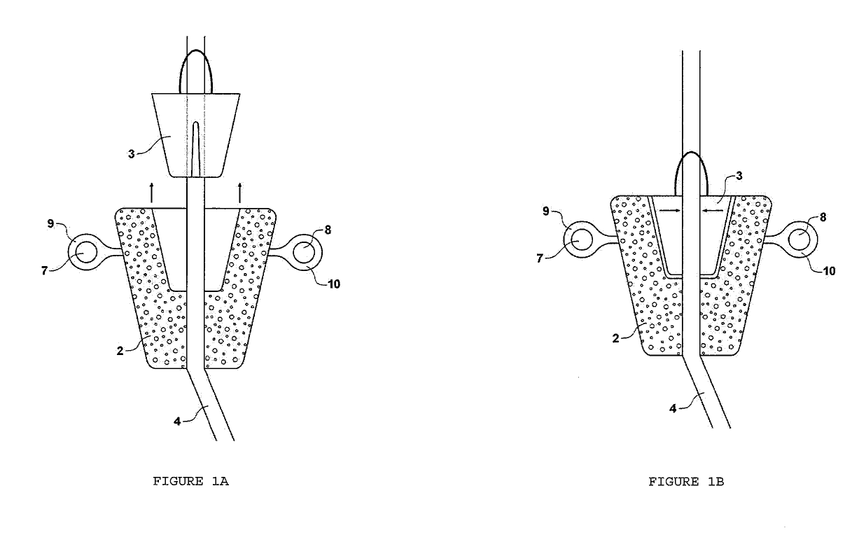

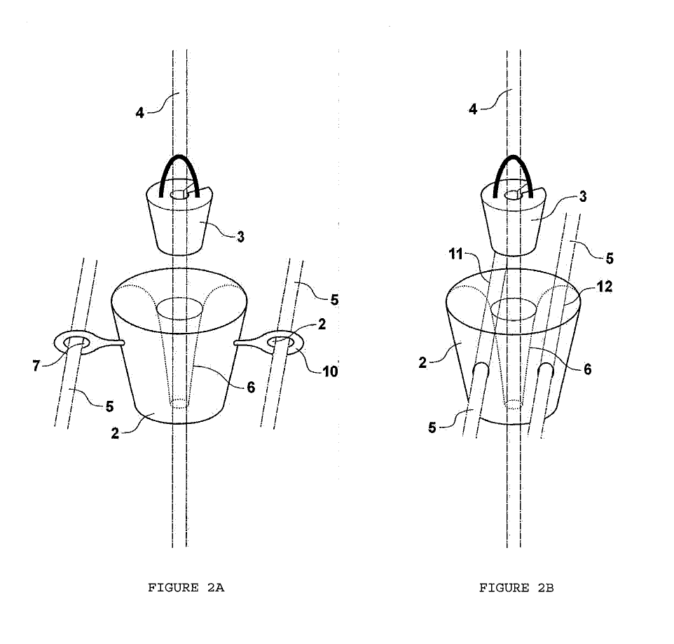

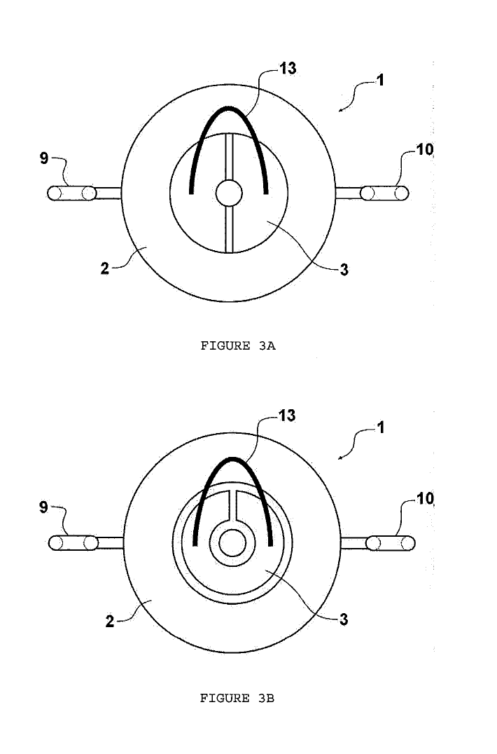

In the embodiments of the releasably submersible float assembly (1) illustrated in FIGS. 1, 2 and 3, the float body (2) is adapted for use in conjunction with a mooring line (4) by being provided with a conduit (6) through which the mooring line (4) may pass. The float body (2) is further adapted for use with one or more support lines (5) by being provided with further conduits (7, 8) through which the support lines (5) may pass. The conduits (7, 8) for the mooring line (4) and the support lines (5) are in an orthogonal relationship. The conduits for the support lines may be provided by a number of means, including eye rings (9, 10) attached to the outer surface of the float body (2) (FIGS. 1, 2A and 3) or tubular voids (11, 12) passing through the body of the float body (2) (FIG. 2B). The float body (2) of the releasably, submersible float assembly illustrated in FIGS. 1, 2A and 3 is provided with outwardly opposing eye rings (9, 10) through which each of a pair of support lines (5) may pass. In use, the retainer (3) of the float assembly (1) functions to prevent the float body (2) being driven to the surface of the medium in which it is immersed. In a non-cooperative engagement the retainer (3) is releasably engaged with the mooring line at a location above which the float body is to be retained. In a non-cooperative engagement the retainer (3) is releasably engaged with the mooring line independently of the float body (2). In cooperative engagement it is the buoyancy of the float body (2) that actuates the releasable engagement of the retainer (3) with the mooring line (4).

An advantage of the preferred cooperative engagement is that the engagement may be released simply by pressing down on the upper side of the float body (2). The cooperative engagement with the mooring line (4) is no longer promoted and the float body may then be depressed to a lower position on the mooring line (4) or allowed to rise to a higher position on the mooring line whilst lifting the retainer (3) via its releasing handle (13). Once the float body is just below the desired location on the mooring line the cooperative engagement may be re-established by allowing the retainer (3) to be received by the upper open mouth of the conduit passing through the body of the float body (2) (see FIGS. 1A and 1B).

The retainer (3) can take a number of forms. In a preferred form the retainer (3) is a split collar having a tapered profile adapted for use in conjunction with the float body (2). The tapered profile of the retainer complements that of the upper open mouth of the conduit through which the mooring line (4) passes. In cooperative engagement the buoyancy of the float body (2) causes the split ring collar retainer to be constricted and engage with the mooring line (4). The buoyancy of the float body (2) is necessarily countered by holding the retainer (3) at the desired location. It will be recognised that the apparatus required to both promote and release the cooperative engagement when the releasably submersible assembly (1) is used at shallow depths can be as simple as a pole with a hook at one end or a pair of such poles (not shown).

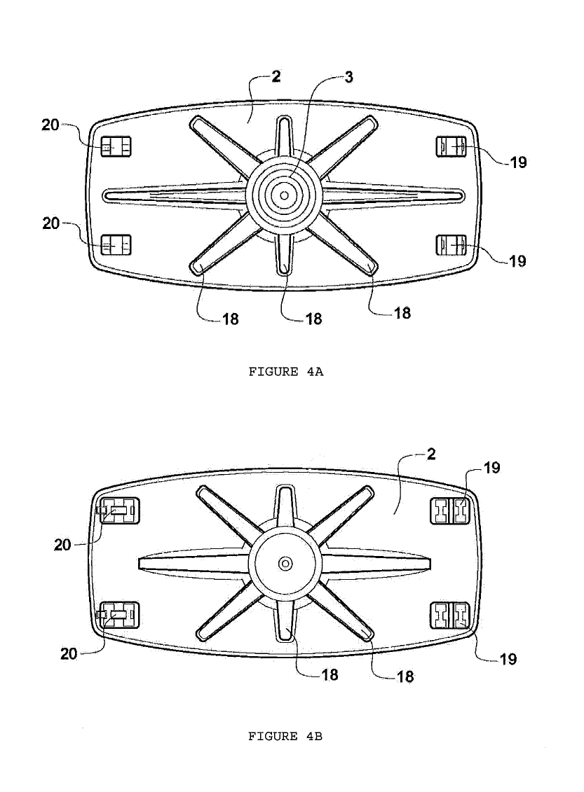

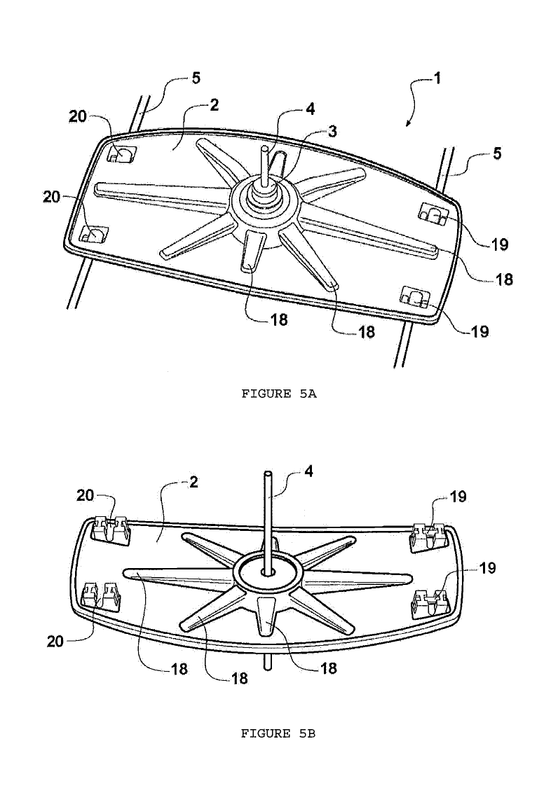

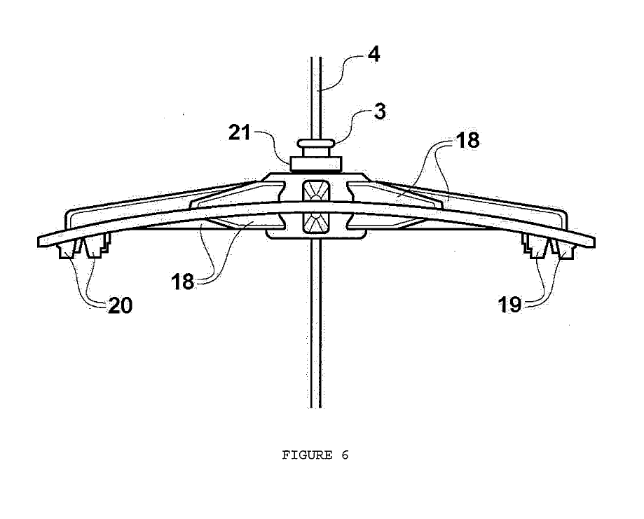

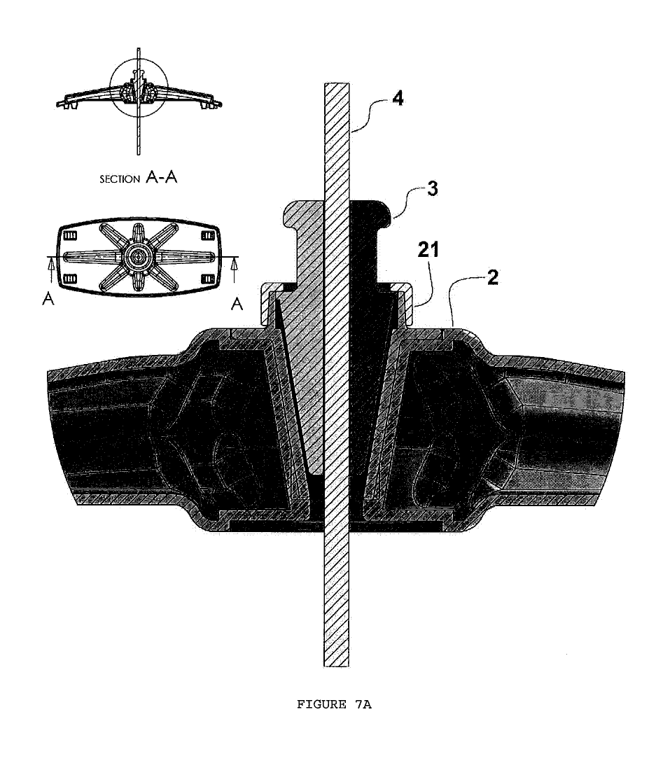

The float body (2) of the particularly preferred embodiment of the releasably submersible float assembly illustrated in FIGS. 4 to 7 is manufactured by blow or rotational moulding to provide a nominal wall thickness of 6 mm. Typically the float body (2) is moulded from polyethylene (density 950 Kg/m³), but may be moulded from other suitable materials such as polypropylene or polyvinylchloride. When moulded from polyethylene with the stated nominal wall thickness and approximate dimensions of 150 cm (length), 75 cm (width) and 24 cm (depth) (accommodating the curvature of the flattened elongate float body) the float body has an approximate mass of 17 Kg and a volume of 49 litres providing a buoyancy of 32 Kg and mean density of 0.35 g/mL.

The integral spars (18) provide the float body (2) with rigidity and strength. The float body (2) is also provided with a pair of means (19, 20) for releasably retaining support lines located at or proximal to each end of the float body (2). The support lines may be releasably retained through the use of any suitable combination of a gate with a jaw or recess. In a gate and jaw configuration the gate may be biased towards a closed (retaining) position, e.g. a carabiner. In an alternative gate and jaw configuration the gate is provided by a member slidable between an open (releasing) and closed (retaining) position. In yet another configuration the function of the gate may be performed by the distal ends of the arms of the jaw being biased towards each other so as to retain the support line. When the arms of the jaw are manufactured from a resilient material the support lines may be released simply by pulling the support line in a direction perpendicular to its length through the mouth of the jaw.

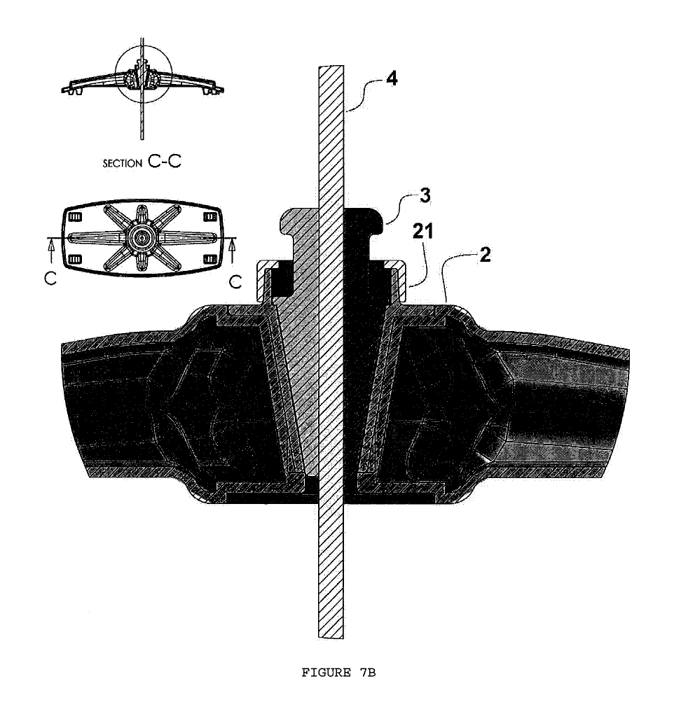

The upper open mouth of the conduit through which the mooring line (4) passes is dimensioned to receive a retainer (3) slidably held within a sleeve (21). The retainer (3) may be injection moulded from glass fibre reinforced nylon. A first portion of the body of the retainer (3) has a profile that is tapered, being of an inverted truncated cone shape. This portion of the body of the retainer participates in the cooperative engagement as shown in FIGS. 7A (released) and 7B (engaged). A second portion of the body of the retainer (3) provides as handle or area where the retainer (3) may be gripped and moved between the positions shown in FIG. 7.

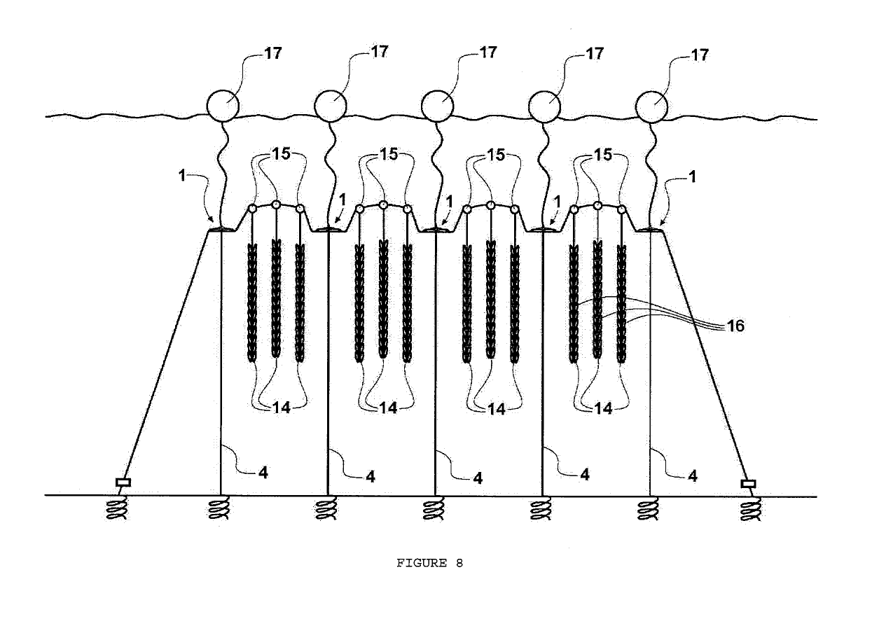

The float body (2) is dimensioned so that the support lines (5) are retained at a distance apart suitable for use in a longline culture system of the “double backbone” configuration. The use of the particularly preferred embodiment of the releasably submersible float assembly (1) in this configuration will now be described with reference to FIG. 8 showing an example of the submersible culture system.

In this submersible longline culture system, growing ropes (14) are suspended in the water column from the support lines (5). In the “double backbone” configuration shown in FIG. 8 a pair of support lines (5) is tethered to the seabed at each end. The tethering is such that the support lines are permitted to rise to the surface when the engagement of the float assemblies (1) with the mooring lines (4) is released. In a variant of the system, the support lines need not be tethered to the seabed, but fixedly connected to a terminal support float.

The system is provided with sufficient support floats (15) spaced apart and attached between the pair of support lines (5) to support the lines and the growing mussel harvest (16). A plurality of intermediate mooring lines (4) are anchored to the seabed along the length of the pair of support lines (5), each of the intermediate mooring lines (4) being suspended from the water surface by a marker float (17). Each of the mooring lines (4) passes through the conduit passing through the body of each of the float bodies (2) of the float body assemblies (1). Each of the two support lines (5) are releasably retained by the means (19, 20) provided at or proximal to each end of each of the float bodies (2) of the float body assemblies (1). The axes of the mooring line (4) and the pair of support lines (5) are in a substantially orthogonal relationship. The pair of support lines (5) and associated growing ropes (14) may then be releasably submerged by use of the float assembly (1) as described above.

In a particularly facile mode of use each assembly (1) is submerged by pressing downward on the upper side of the float body (2) until the support lines (5) have been submerged to a first depth. On release of the downward pressure the buoyancy of the float body (2) urges it towards the surface, but is prevented from reaching the surface by cooperative engagement with the retainer (3). Where the retainer is of the split collar with tapered profile form, the longitudinal forces attributable to the buoyancy of the float body are translated into lateral forces causing the split collar to engage with the mooring line (4). The procedure is repeated for each of the other float assemblies (1) incorporated into the “double backbone”.

It is recognised that the buoyancy provided by the support floats may be too great for all of the float assemblies (1) to be submerged to the desired depth at the same time. It is contemplated that the pair of support lines (5) and associated support floats (15) will be submerged to a first depth before being submerged to the desired depth by each of the assemblies (1) being submerged to a first depth and the procedure repeated in a stepwise fashion. As these procedures can be performed from a vessel on the water surface the requirement for support frames of the type described in the publications of Diaz Arbonez (2010), Quinta Cortinas and Diaz Arbonez (2004 and 2006) is avoided.

It will be appreciated that this description is illustrative of the utility of the releasably submersible float assembly and is not intended to be limiting to its use solely in aquaculture. Although the invention has been described with reference to embodiments or examples it will be appreciated that variations and modifications may be made to these embodiments or examples without departing from the scope of the invention. These variations and modifications include variations and modifications to the abutting faces of the float body (2) and retainer (3) when in cooperative engagement with the mooring line (4). These variations and modifications may include providing the abutting surfaces with complementary profiles, e.g. of a “screw-and-thread” type.

Where known equivalents exist to specific elements, features or integers, such equivalents are incorporated as if specifically referred to in this specification. In particular, variations and modifications to the embodiments or examples that include elements, features or integers disclosed in and selected from the referenced publications are within the scope of the invention unless specifically disclaimed. The advantages provided by the invention and discussed in the description may be provided in the alternative or in combination in these different embodiments of the invention.

### REFERENCED PUBLICATIONS

Creswell and McNevin (2008) Better management practices for bivalve molluscan aquaculture In Environmental Best Management Practices for Aquaculture Eds. Tucker and Hargreaves Publ. John Wiley and Sons, Inc.

Diaz Arbonez (2010) Improved submersible raft International application no. PCT/ES2010/000346 (publ. no. WO 2010/139832 A1).

Fiotakis (1991) Retrievable and submersible buoy International application no. PCT/AU90/00368 (publ. no. WO 91/02676 A1).

Lloyd (2003) Potential effects of mussel farming on New Zealand's marine mammals and seabirds—a discussion paper. Department of Conservation, Wellington, New Zealand.

Oettinger (2002) Submersible mooring device provided with own deflation means European patnet application No. 01121148.9 (publ. no EP 1186528 A1).

Quinta Cortinas and Diaz Arbonez (2004) Improved submersible farm International application no. PCT/ES2003/000316 (publ. no. WO 2004/00220 A1).

Quinta Cortinas and Diaz Arbonez (2006) Improved submersible farm International application no. PCT/ES2005/000435 (publ. no. WO 2006/030042 A1).

1-22. (canceled)

23. A releasably submersible float assembly for use with a mooring line comprising:
a float body having a conduit through which the mooring line may pass; and
a retainer that releasably engages with the mooring line to maintain the float body at a desired depth,
where the releasable engagement of the retainer with the mooring line is actuated by the buoyancy of the float body abutting the retainer.

24. The assembly of claim 23 where the conduit through which the mooring line passes is through the body of the float body.

25. The assembly of claim 24 where the upper open mouth of the conduit through which the mooring line passes is dimensioned to receive the retainer and at least a portion of the outer surface of the body of the retainer has a tapered profile.

26. The assembly of claim 25 where the float body is provided with a pair of means for retaining support lines.

27. The assembly of claim 26 consisting essentially of:
an arcuate flattened elongate float body with integral rigidity providing spars projecting radially from around a centrally located conduit through which the mooring line may pass and a means for retaining support lines located at or proximal to each end of the float body; and
a retainer slidably held within a sleeve attached to the upper surface of the float body coaxial with the conduit.

28. A method of culturing bivalve mollusc in submerged culture comprising the use of a releasably submersible float assembly of claim 23.

29. A method of culturing bivalve mollusc in submerged culture comprising the use of a releasably submersible float assembly of claim 24.

30. A method of culturing bivalve mollusc in submerged culture comprising the use of a releasably submersible float assembly of claim 25.

31. A method of culturing bivalve mollusc in submerged culture comprising the use of a releasably submersible float assembly of claim 26.

32. A method of culturing bivalve mollusc in submerged culture comprising the use of a releasably submersible float assembly of claim 27.
